(19) United States
(12) Patent Application Publication
(10) Pub. No.: US 2004/0015571 A1
(43) Pub. Date: Jan. 22, 2004

(54) Dynamic determination of network configuration

(75) Inventors: Toshiya Miyazaki, Kawasaki (JP); Shigehiro Idani, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/282,134

(22) Filed: Oct. 29, 2002

(30) Foreign Application Priority Data
Jul. 16, 2002 (JP) 2002-206957

(51) Int. Cl. G06F 15/177

(52) U.S. Cl. 709/220

(57) ABSTRACT

An information processing apparatus is connectable to a plurality of devices via a local area network. The information processing device includes means for acquiring data related to at least functions and operating states of the plurality of devices; and means for dynamically determining a configuration of the network in accordance with the acquired data and with a predetermined rule for a network configuration.

### FIELD OF THE INVENTION

The present invention relates to dynamic determination of a network configuration, and more particularly to determining or assigning functions to be activated from among different functions of a plurality of devices interconnected via a local area network, in accordance with abilities and operating states of the respective devices.

### BACKGROUND OF THE INVENTION

These days, in offices and homes, a plurality of devices, such as one or more personal computers, a scanner, a printer, a router and the like can be interconnected via a local area network. As functionality of software is enhanced, an existing device may be subjected to an undesirable high load that was not expected at the time when the device was manufactured. Devices manufactured several years ago, or devices having faulty component parts may not be used because of their relatively low processing abilities even if they are at least partially usable.

In Japanese Unexamined Patent Publication No. 2000-259292 (A), entitled “POWER CONTROL METHOD, ELECTRONIC APPARATUS, AND RECORDING MEDIUM”, Sotokawa discloses managing the total power consumption of a plurality of machines connected to one power supply, wherein the management is performed by controlling the power consumption of each machine so that the total power consumption does not exceed the capacity of the power supply.

In Japanese Unexamined Patent Publication No. 2001-306195 (A), entitled “POWER SAVING MODE CONTROL UNIT”, Sano et al. disclose control means for instructing a power saving state of an electronic device in accordance with information on the state detected when the electronic device is connected to a network.

The inventors have recognized the need for making different functions of a plurality of devices connected to a local area network available for use in accordance with the current abilities and states of the respective devices.

An object of the present invention is to make different functions of a plurality of devices connected to a network available for use in accordance with the abilities of the respective devices.

### SUMMARY OF THE INVENTION

In accordance with an aspect of the present invention, an information processing apparatus is connectable to a plurality of devices via a local area network. The information processing device includes means for acquiring data related to at least functions and operating states of the plurality of devices; and means for dynamically determining a configuration of the network in accordance with the acquired data and with a predetermined rule for a network configuration.

The determining means may analyze the acquired data to determine ones of the plurality of devices that have equivalent functions.

The determining means may send, in accordance with the determined configuration, a control signal over the network to a particular one of the plurality of devices.

In accordance with another aspect of the invention, a program (which may be stored on a storage medium) is for use in an information processing apparatus connectable to a local area network. The program is operable to effect the step of acquiring data related to at least functions and operating states of a plurality of devices; and the step of dynamically determining a configuration of the network in accordance with the acquired data and with a predetermined rule for a network configuration.

In accordance with a still further aspect of the invention, a method for determining a configuration of a local area network is for use in an information processing apparatus connectable to the network. The method comprises the step of acquiring data related to at least functions and operating states of a plurality of devices; and the step of dynamically determining the configuration of the network in accordance with the acquired data and with a predetermined rule for a network configuration.

According to the invention, functions of a plurality of devices configured to a local area network can be used in accordance with abilities of the respective functions.

Throughout the drawings, similar symbols and numerals indicate similar items and functions.

### BRIEF DESCRIPTION OF THE DRAWINGS

FIG. 1 shows a schematic configuration of a plurality of devices which are interconnected via a local area network (LAN), in accordance with an embodiment of the present invention.

FIG. 2 shows relevant internal configurations of a monitoring device having a device monitoring function and of other devices to be monitored by the monitoring device, which devices are interconnected via a LAN, in accordance with the embodiment of the invention.

FIG. 3 shows an example of a procedure for communications between the monitoring device and the devices to be monitored.

FIG. 4 shows a flow chart to be executed by an optimization module when the rules to be applied define that a related device that is closest to the device being operated by the user is activated, that power consumption is minimized, and that a priority is given to the activation of the related device that is closest to the device being operated by the user.

FIG. 5 shows a process flow when the rules to be applied define that power consumption is minimized, that the processing speed for execution is maximized, and that a priority is given to either the minimization of the power consumption or the maximization of the processing speed.

### DESCRIPTION OF THE PREFERRED EMBODIMENTS

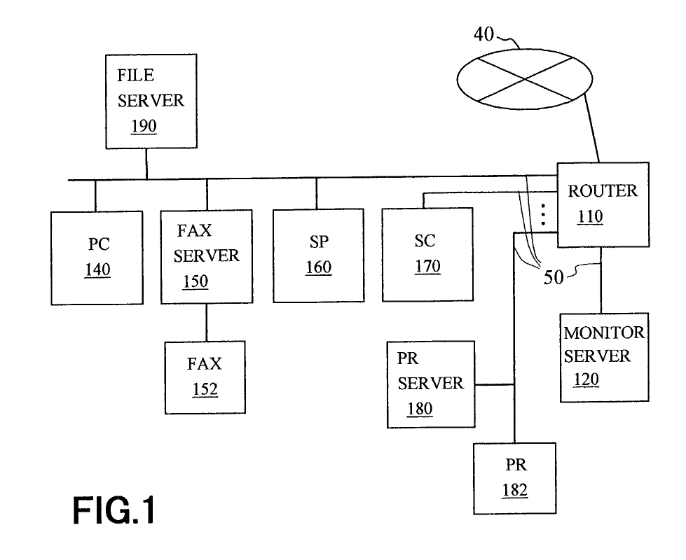

FIG. 1 shows a schematic configuration of a plurality of devices which are interconnected via a local area network (LAN) 50, such as a bus in a home or office environment, in accordance with an embodiment of the present invention. A monitor server 120, a personal computer (PC) 140, a facsimile server 150, a facsimile device 152, a speaker 160, a scanner 170, a print server 180, a printer 182, and a file server 190 are interconnected via the LAN 50 which is configured with a router 110.

The router 110 is connected to an external network 40, such as the Internet. The router 110 has such functions as a firewall, address translation, DHCP (Dynamic Host Configuration Protocol) and the like.

The LAN 50 may be a wireless LAN. In this case, the router 110 also serves as a wireless access point, and the devices 120 to 190 communicate with the wireless access point 110 via their wireless transceivers. A partially faulty device, for example, a PC having a faulty display device or a faulty CD drive, may be connected to the LAN 50.

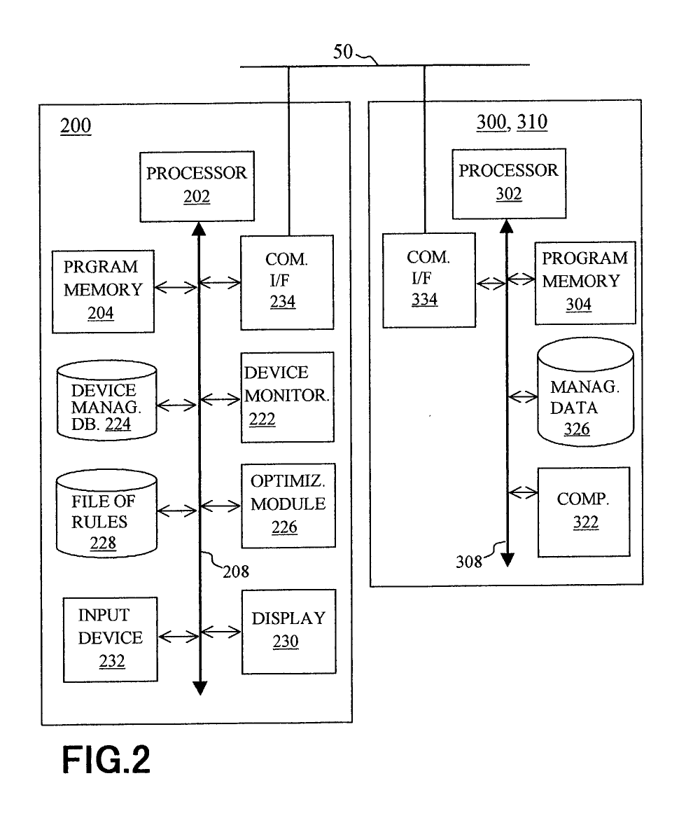

FIG. 2 shows relevant internal configurations of a device 200 having a device monitoring function (hereinafter referred to as the monitoring device) and of other devices 300 and 310 to be monitored by the monitoring device 200, which are interconnected via the LAN 50, in accordance with the embodiment of the invention.

The monitoring device 200 includes a processor 202 having a CPU, a ROM and a RAM, a program memory 204, a device monitoring module 222, a network configuration optimization module 226 coupled to the device monitoring module 222, a device management data base 224 stored in a storage device such as a hard disk unit, a file of network configuration rules or control rules 228 stored in the storage device, a display device 230, an input device 232 such as a keyboard and a mouse, and a communication interface (I/F) 234, all of which are interconnected via an internal bus 208.

The program memory 204 stores application programs to be executed by the processor 202, for example, programs for device monitoring, network configuration optimization, and communications via the LAN 50. When the LAN 50 is a wireless LAN, the communication interface 234 includes a wireless or RF transceiver.

The device management data base 224 stores management data which is collected from the devices 300 and 310 configured to the LAN 50, as will be described later. The rule file 228 contains rules for optimizing the network configuration of the LAN 50 in accordance with the management data of the respective devices. The network configuration here means not only the configuration of the devices connected to the LAN 50, but also the configuration within each device, i.e., the configuration of components and functions of each device. The rules include, for example, minimizing the power consumption of the LAN 50, maximizing the speed of processing performed in the LAN 50, activating a related device that is closest to the device being operated in the LAN 50 by a user, giving a higher priority to the minimization of the power consumption and the maximization of the processing speed than the activation of the closest related device, giving the highest priority to the minimization of the power consumption, giving the highest priority to the maximization of the processing speed rather than the minimization of the power consumption, and giving the highest priority to the activation of the related device closest to the device being operated by the user. The user can select which of these rules is to be applied.

Each of the devices 300 and 310 includes a processor 302 having a CPU, a ROM and a RAM, a program memory 304, a management data file 326 stored in a storage device such as a hard disk unit, and other components 322, all of which are interconnected via an internal bus 308.

The program memory 304 stores application programs to be executed by the processor 302, for example, programs for the function of the device, component management within the device, and communications. When the LAN 50 is a wireless LAN, the communication interface 334 includes a wireless transceiver.

The management data file 326 contains: a device type of each of the devices 300 and 310; an identification and an address of each device; functions of each device, for example, processing ability, storage capacity, and nominal power consumption in each mode of operation; an operating state and a setup state, for example, a halt mode of operation/a standby mode of operation/a normal mode of operation, presence or absence of failure, a currently activated internal function, and a user's operating state; a current configuration within the device (300, 310); a location of the device in a home or an office; information on an operation history; and functions and operating states of other devices related and connected to the device (300, 310), and the like. The operating state information includes information about a device failure or fault as well as a component failure or fault within the device.

As shown in FIG. 1, the monitoring device 200 may be a dedicated monitor server 120 which has the device monitoring module 222 and the optimization module 226, or may be the PC 140, the facsimile server 150 or the print server 180 which has the device monitoring module 222 and the optimization module 226. The monitoring module 222 is implemented in the form of hardware or software. If it is a software program, the program is stored in the memory 204, and the processor 202 operates in accordance with the program.

Each of the monitored devices 300 and 310 may be any of the devices other than the monitoring device 200. For example, it may be the PC 140, the facsimile server 150, facsimile device 152, the speaker 160, the scanner 170, the print server 180 or the printer 182. In addition to the monitored devices 300 and 310, the plurality of components 322 within each of the devices 300 and 310 may be monitored individually.

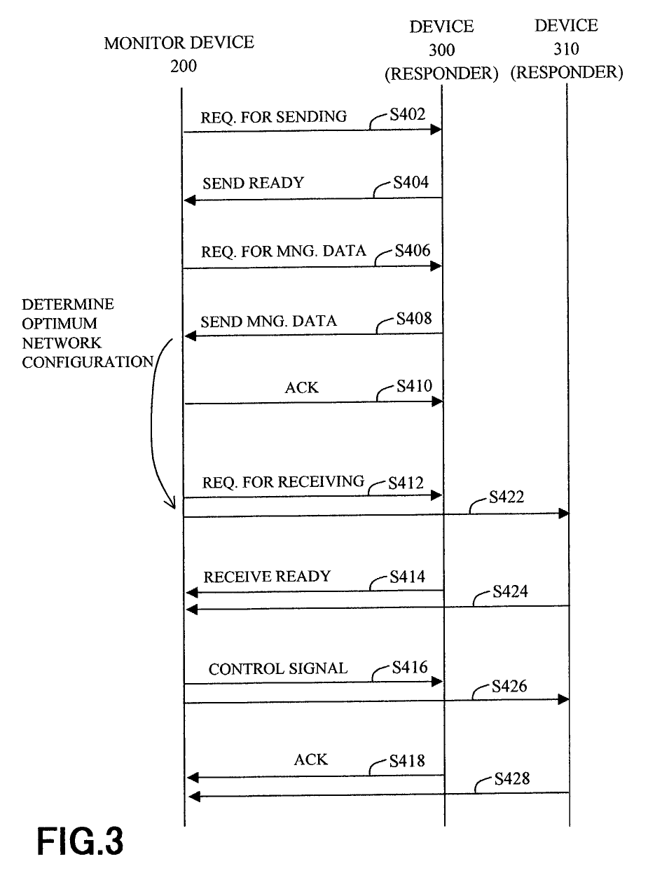

FIG. 3 shows an example of a procedure for communications between the monitoring device 200 and the devices 300 and 310. For the purpose of explanation, it is assumed that the monitoring device 200 is the monitor server 120. It is also assumed that each of the devices 300 and 310 is one of the other devices, for example, the PC 140, facsimile server 150, the print server 180 or the file server 190. Each of the device 300 and 310 monitors its own current operating state, and records management data representing the operating state in the management data file 326. The monitoring device 200 periodically polls, for example, the device 300, collects and analyzes the management data of the device 300, and, if necessary, controls the device 300 and 310 accordingly. Communications between the devices for such monitoring and control should be performed in accordance with the FTP (File Transfer Protocol) or HTTP (HyperText Transfer Protocol). When the device 300 is first connected to the LAN 50, the monitoring device 200 operates in the same manner as described above and collects its management data.

Referring to FIGS. 2 and 3, the device monitoring module 222 in the monitoring device 200 periodically requests the management data of the other device 300 (310) from the communication function of the processor 202. At Step 402, in response to the management data request, the processor 202 in the monitoring device 200 sends, to the other device 300 (310) connected to the LAN 50, a request for sending via the communication interface 234 by polling the other device 300 (310).

The devices 300 and 310 connected to the LAN 50 are operating in either the normal mode of operation, the standby mode of operation, or the sleep mode of operation with minimum power consumption which ensures initiation of at least communications with the monitoring device 200. At Step 404, in response to the sending request, the processor 302 in the device 300 activates its communication function and transmits a send ready message back to the monitoring device 200. At Step 406, in response to the reception of the send ready message, the processor 202 in the monitoring device 200 transmits a request for sending management data to the device 300.

At Step 408, in response to the management data request, the processor 302 in the device 300 retrieves the management data stored in the management data file 326, and sends it to the monitoring device 200. Upon receiving the management data, the processor 202 in the monitoring device 200 at Step 410 transmits an acknowledgement of the received data back, and passes the received management data to the device monitoring module 222. The device monitoring module 222 in the monitoring device 200 stores the received management data in the device management data base 224.

After that, the optimization module 226 in the monitoring device 200 analyzes the device management data just stored in the device management data base 224. The optimization module 226 determines an optimum network configuration for the LAN 50 in accordance with the analysis and the applicable rules stored in the rule file 228. If the determined configuration is different from the current configuration, the optimization module 226 sends a control instruction or control signal for optimizing the operation of the devices 300 and/or 310 in accordance with the determined configuration.

Referring to FIGS. 2 and 3, the optimization module 226 in the monitoring device 200 requests the communication function of the processor 202 to send the control signal to the devices 300 and/or 310. At Steps 412 and 422, in response to the request for sending a control signal, the processor 202 in the monitoring device 200 transmits requests for receiving to the devices 300 and 310, respectively. At Steps 414 and 424, in response to reception of the reception request, the processor 302 in each of the devices 300 and 310 transmits a receive ready message back to the optimization module 226.

At Steps 416 and 426, in response to the reception of the receive ready message, the processor 202 in the monitoring device 200 sends the control signals to the respective devices 300 and 310, respectively. The processor 302 in each of the devices 300 and 310 controls the operation of each of the devices 300 and 310, for example, the operation of the component 322 such as a power control, in accordance with the received control signal. The optimization module 226 may further control the operation of the components and functions of the monitoring device 200 in accordance with the optimum network configuration.

It is assumed, for example, that the device 300 is the PC 140, and that the user has activated the PC 140, causing it to transition from the sleep mode of operation to the normal mode of operation. Shortly after the PC 140 is connected to the LAN 50, the monitoring module 222 in the monitoring device 200, in accordance with the communication procedure of FIG. 3 (Steps 402 to 410), acquires from the PC 140 the current management data of the PC 140 indicating that the device type of the PC 140 is a PC, that the function is a PC function, that the current operating function is a Web browser, that the current state of operation is the normal mode of operation, that the installed location of the PC 140 is a living room, that the user is currently operating the PC 140, and the like.

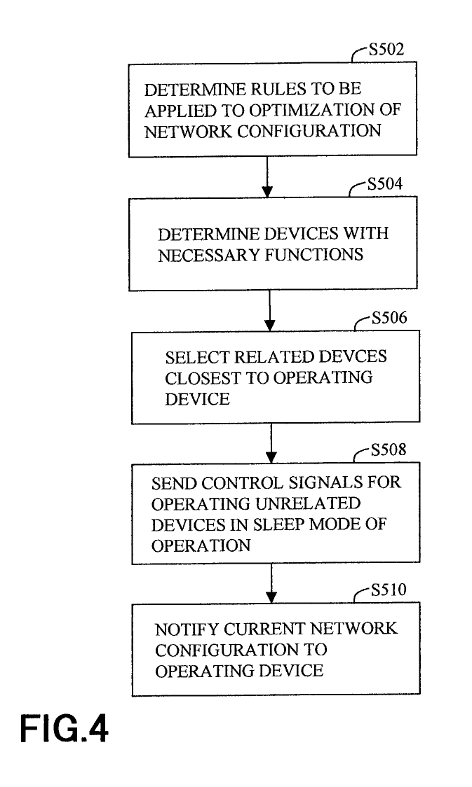

FIG. 4 shows a flow chart to be executed by the optimization module 226 when the rules to be applied define that a related device that is closest to the device being operated by the user is activated, that the power consumption of the LAN 50 is minimized, and that a priority is given to the activation of the related device that is closest to the device being operated by the user.

Referring to FIG. 4, at Step 502 the optimization module 226 retrieves the applicable rules selected by the user from the rule file 228, to determine the rules to be applied for the optimization of the network configuration. At Step 504, the optimization module 226 determines a device configured to the LAN 50 and having the functions related to or necessary for the currently activated function (Web browser) of the PC 140. A plurality of devices that have at least one same necessary function may be determined. At Step 506, the optimization module 226 selects, in accordance with the determined rules, necessary ones, such as the speaker 160, the print server 180 and the printer 182, of the devices that have the necessary functions and that are closest to the installed location of the PC 140.

At Step 508, the optimization module 226 sends, to each necessary device, a control signal for operating the device in the normal mode of operation, and also sends, to each necessary device, a control signal for activating any necessary components or functions of the device. On the other hand, the optimization module 226 sends, to any devices unrelated to or unnecessary for the operation of the currently operating PC 140, control signals for deactivating the power supply of the unnecessary devices to thereby cause the devices to operate in the sleep mode of operation. Further, the optimization module 226 sends, to each operating related device, a control signal for deactivating any unnecessary components or functions of the device.

At Step 510, the optimization module 226 sends the information on the current network configuration to the currently operating PC 140 for display thereon to notify the user. The necessary devices, for example, the speaker 160, the print server 180, and the printer 182, operate in accordance with instructions or requests issued from the PC 140.

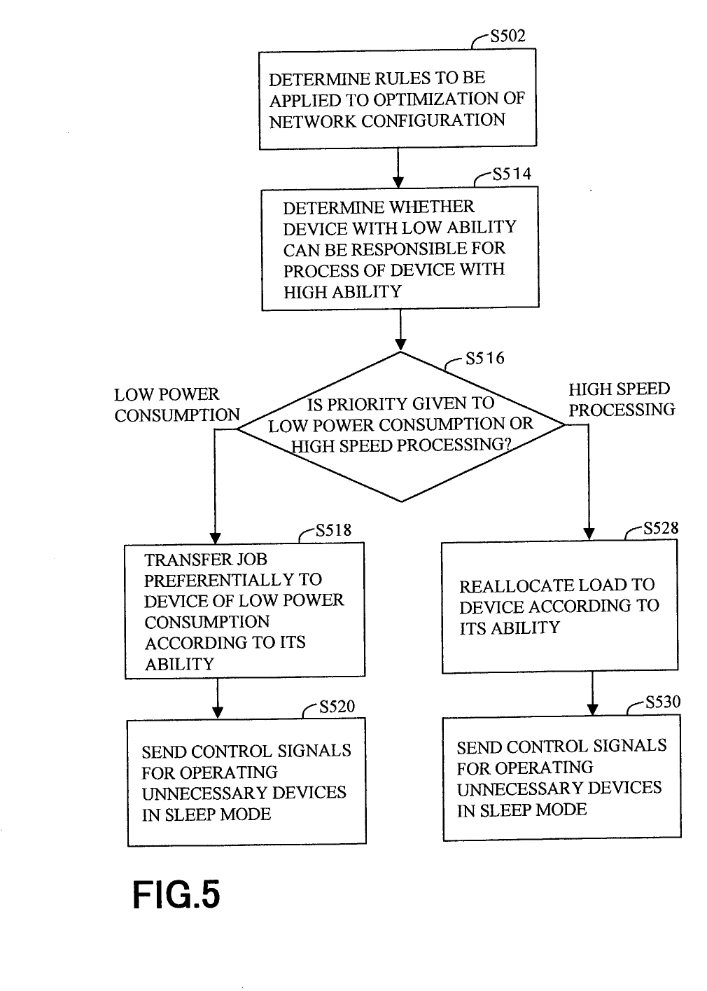

FIG. 5 shows a process flow when the rules to be applied define that the power consumption of the LAN 50 is minimized, that the speed of processing performed in the LAN 50 is maximized, and that a priority is given to either the minimization of the power consumption or the maximization of the processing speed. The user can preset the priority between them by using the input device 232 of the monitoring device 200 while viewing the display device 230.

Referring to FIG. 5, at Step 502, the optimization module 226 determines the rules to be applied for the optimization of the network configuration. At Step 514, the optimization module 226 refers to the device management data base 224 to determine whether a device having a low processing ability can be responsible for the process of a function of a device having a high processing ability for reallocation of a load.

At Step 516, the optimization module 226 checks the currently set rule to see whether the priority is given to the minimization of the power consumption or to the maximization of the processing speed.

If it is determined that the priority is given to the minimization of the power consumption, then the optimization module 226 at Step 518 causes a low power consumption device having the same function to operate in the normal mode of operation, sends, to the necessary device, the control signal for activating any necessary components or functions of the necessary device, and controls the related devices within the LAN 50 so that jobs are transferred preferentially to that device or components but so as not to exceed its processing ability. At Step 520, the optimization module 226 sends, to any unnecessary devices, the control signals for operating the unnecessary devices in the sleep mode of operation. Further, the optimization module 226 sends, to each operating related device, the control signal for deactivating any unnecessary components or functions of the device.

On the other hand, if it is determined at Step 516 that the priority is given to the maximization of the processing speed, then the optimization module 226 at Step 528 sends a control signal for operating a device having the same function in the normal mode of operation in accordance with its processing ability and also a control signal for activating any necessary components or functions of the necessary device, and reallocates the processing load or job to the device or components, to thereby maximize the processing speeds of the network devices as a whole. The job reallocation may be performed dynamically in accordance with the type of data, the type of processing, and the processing schedule. The processing load may include, for example, the reception of an audio/video data stream by the PC 140 via the external network 40 and the router 110, the storing of the received data stream into the storage device of the file server 190, and the decoding of the stored data stream by the PC 140. At Step 530, the optimization module 226 sends, to any unnecessary device, the control signal for causing the unnecessary device to operate in the sleep mode of operation. Further, the optimization module 226 sends, to each operating related device, the control signal for deactivating any unnecessary components or functions of the device. For example, when the reception and storage of the data stream have been completed, the modules in the PC 140 necessary for the reception become unnecessary and are thus deactivated even if the data stream is in the process of being decoded.

It is assumed, for example, that the applied rule defines that the priority is given to the maximization of the processing speed, and that the facsimile server 150 having a high processing ability is the operating. Then, it is assumed that the facsimile server 150 having high processing capability has failed during operation. At Steps 402 to 410 of FIG. 3, the monitoring module 222 in the monitoring device 200 receives, from the facsimile server 150, the management data of the facsimile server 150, including its failure data, and stores the received data in the management data base 224. At this time, the monitoring device 200 may indicate the failure of the facsimile server 150 on the display device 230.

Now, at Step 528 of FIG. 5, the optimization module 226 in the monitoring device 200 determines the optimum network configuration in accordance with the rule that gives the priority to the maximization of the processing speed, and selects the print server 180 having a function that can substitute for the facsimile server 150. At Steps 412 to 418 of FIG. 3, the monitoring module 222 sends a control signal to the facsimile server 150 to cause it to operate in the sleep mode of operation and, at Steps 422 to 428 of FIG. 3, sends a control signal to the print server 180 to activate the facsimile server function part of the print server 180.

As another example, its is assumed that the applied rule defines that the priority is given to the minimization of the power consumption. Also it is assumed that, while the PC 104 is being used by the user, the gateway server function to be used for communications with the external network 40 is allocated to the low power consumption PC 140. After that, when the user has finished using the PC 140, the monitor server 120 activates its own gateway server function instead, and causes the PC 140 to operate in the sleep mode of operation, to thereby minimize the power consumption of the LAN 50.

In the above embodiment, the monitoring device 200 collects the management data by polling the other devices 300 and 310. Alternatively, provisions may be made so that the other devices 300 and 310 automatically send their management data to the monitoring device 200 when there occur changes in their operating states.

The above-described embodiment is only a typical example, and its modifications and variations are apparent to those skilled in the art. It should be noted that those skilled in the art can make various modifications to the above-described embodiment without departing from the principle of the invention and the accompanying claims.

What is claimed is:

1. An information processing apparatus connectable to a plurality of devices via a local area network, comprising:
means for acquiring data related to at least functions and operating states of said plurality of devices; and
means for dynamically determining a configuration of said network in accordance with said acquired data and with a predetermined rule for a network configuration.

2. An information processing apparatus according to claim 1, wherein said determining means dynamically determines the configuration of said network in accordance with a plurality of such predetermined rules to which priorities are assigned.

3. An information processing apparatus according to claim 1, wherein a plurality of such predetermined rules are provided, and said plurality of predetermined rules include minimization of the power consumption and maximization of the processing speed in the configuration of said network.

4. An information processing apparatus according to claim 1, wherein said acquiring means is adapted to receive said data from said plurality of devices over said network.

5. An information processing apparatus according to claim 1, wherein said data further includes data related to the location and the power consumption of each of said plurality of devices.

6. An information processing apparatus according to claim 1, wherein said determining means analyzes said acquired data to determine ones of said plurality of devices that have equivalent functions.

7. An information processing apparatus according to claim 1, wherein said determining means sends, in accordance with said determined configuration, a control signal over said network to a particular one of said plurality of devices.

8. An information processing apparatus according to claim 1, wherein said determining means analyzes said acquired data and, in accordance with said analysis and with said predetermined rule, sends a control signal for deactivating a particular one of said plurality of devices and also sends a control signal for activating another one of said plurality of devices that has a function equivalent to that of said particular device.

9. An information processing apparatus according to claim 1, wherein said determining means analyzes said acquired data and, in accordance with said analysis and with said predetermined rule, sends a control signal for allocating processing loads to ones of said plurality of devices that have equivalent functions.

10. An information processing apparatus connectable to a local area network, comprising:
means for holding data related to a function and an operating state of at least said information processing device;
means being adapted to send said data to another device; and
means being adapted to receive, from said other device over said network, a control signal for controlling said information processing apparatus that is determined in accordance with said data and with a predetermined rule for a network configuration.

11. A program stored on a storage medium for an information processing apparatus connectable to a local area network, said program being operable to effect the steps of:
acquiring data related to at least functions and operating states of a plurality of devices; and
dynamically determining a configuration of said network in accordance with said acquired data and with a predetermined rule for a network configuration.

12. A program according to claim 11, wherein the step of acquiring comprises receiving said data from said plurality of devices over said network.

13. A program according to claim 11, being operable to further effect the step of analyzing said acquired data to determine ones of said plurality of devices that have equivalent functions.

14. A program according to claim 11, being operable to further effect the step of sending, in accordance with said determined configuration, a control signal over said network to a particular one of said plurality of devices.

15. A program according to claim 11, being operable to further effect the step of analyzing said acquired data and, in accordance with said analysis and with said predetermined rule, sends a control signal for deactivating a particular one of said plurality of devices and also sends a control signal for activating another one of said plurality of devices that has a function equivalent to that of said particular device.

16. A program according to claim 11, being operable to further effect the step of analyzing said acquired data and sends, in accordance with said analysis and with said predetermined rule, a control signal for allocating processing loads to ones of said plurality of devices that have equivalent functions.

17. A program stored on a storage medium for an information processing apparatus connectable to a local area network, said program being operable to effect the steps of:
holding data related to a function and an operating state of at least said information processing device;
sending said data to another device; and
receiving, from said other device over said network, a control signal for controlling said information processing apparatus that is determined in accordance with said data and with a predetermined rule for a network configuration.

18. A method for determining a configuration of a local area network in an information processing apparatus connectable to said network, said method comprising the steps of:
acquiring data related to at least functions and operating states of a plurality of devices; and
dynamically determining the configuration of said network in accordance with said acquired data and with a predetermined rule for a network configuration.

19. A method according to claim 18, further comprising the step of analyzing said acquired data to determine ones of said plurality of devices that have equivalent functions.

20. A method according to claim 19, further comprising the step of sending, in accordance with said determined configuration, a control signal over said network to a particular one of said plurality of devices.
